(19) United States
(12) Patent Application Publication
(10) Pub. No.: US 2014/0353271 A1
(43) Pub. Date: Dec. 4, 2014

(54) MODULAR STORAGE UNIT

(71) Applicant: Ameriwood Industries, Inc., Wright City, MO (US)

(72) Inventors: Eric W Kruse, Seymour, IN (US); Larry Voris, Nashville, IN (US)

(21) Appl. No.: 14/292,360

(22) Filed: May 30, 2014

Related U.S. Application Data
(60) Provisional application No. 61/829,825, filed on May 31, 2013.

(51) Int. Cl. B65G 1/02; A47F 5/01; A47F 5/00

(52) U.S. Cl. CPC B65G 1/026; A47F 5/0018; A47F 5/01
USPC 211/188; 211/194

(57) ABSTRACT

A storage unit includes shelf-support racks and shelves coupled to the racks. Any number of racks and shelves can be used to form a modular storage unit.

This application claims priority under 35 U.S.C. §119(e) to U.S. Provisional Application Ser. No. 61/829,825, filed May 31, 2013, which is expressly incorporated by reference herein.

### BACKGROUND

The present disclosure relates to storage units having shelves, and particularly, to storage units that are modular and expandable. More particularly, the present disclosure relates to a storage unit having shelves that can be mounted on frames without using tools.

### SUMMARY

A storage unit in accordance with the present disclosure includes first and second racks and a first shelf arranged to extend between and engage the first and second racks. In illustrative embodiments, the storage unit is modular and includes more racks and shelves. Each shelf includes an article-support panel and panel-support mounts that engage the rack and are staggered to cooperate with the panel-support mounts of a neighboring shelf to form an alternating pattern of panel-support mounts of two abutting shelves along a boundary line established between the shelves on a rack shared by the abutting shelves.

In illustrative embodiments, the storage unit also includes third and fourth racks and a second shelf arranged to extend between the first and fourth racks and lie in end-to-end coplanar relation to the first shelf. A third shelf included in the storage unit is arranged to extend between the third and second racks and lie in end-to-end coplanar relation to the first shelf. The third, first, and second shelves are arranged to lie in series and are supported by the four racks to form a single shelving level in the storage unit.

In illustrative embodiments, each rack includes an upright tube-support frame and several horizontal shelf-support tubes coupled to the upright tube-support frame. One shelf-support tube is provided on the tube-support frame for each shelf that is to be mounted on the rack. Each shelf includes a horizontal article-support panel, a first pair of panel-support mounts coupled to a first end of the panel and configured to mate with a neighboring shelf-support tube included in one rack, and a second pair of panel-support mounts coupled to an opposite second end of the panel and configured to mate with a companion shelf-support tube included in another rack.

In illustrative embodiments, two panel-support mounts of the first shelf are arranged to lie in alternating relation to the neighboring two panel-support mounts of the second shelf when those panel-support mounts of the first and second shelves mate with a horizontal shelf-support tube shared by the first and second shelves. The alternating pattern of the panel-support mounts of the first and second shelves on the shared shelf-support tube results in no overlapping of a panel-support mount of the first shelf with any neighboring panel-support mount of the second shelf.

In illustrative embodiments, the first shelf includes an inner first panel-support mount that is offset from a nearby first side edge of its article-support panel and an outer first panel-support mount that is adjacent to a nearby second side edge of its article-support panel. In contrast, the second shelf includes an outer second panel-support mount that is adjacent a nearby first side edge of its article-support mount and an inner second panel-support mount that is offset from an adjacent second side edge of its article-support panel.

In illustrative embodiments, when the panels of the first and second shelves are aligned in end-to-end relation to one another to align the first side edges of the panels of the first and second shelves with one another, then (1) each of the four panel-support mounts engages the shelf-support tube located between the first and second shelves and (2) the outer second panel-support mount of the second shelf, the inner first panel-support mount of the first shelf, the inner second panel-support mount of the second shelf, and the outer first panel-support mount of the first shelf are arranged to lie in series along the length of the engaging shelf-support tube. The outer second and inner first panel-support mount form a first side-by-side pair of mounts located near the first side edges of the panels of the first and second shelves. The inner second and outer first panel-support members form a second side-by-side pair located near the second side edges of the panels of the first and second shelves. There is a wide gap between the two side-by-side pairs of mounts in illustrative embodiments.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a modular storage unit in accordance with the present disclosure showing that the unit includes four levels of shelving supported by four spaced-apart racks and showing that a third level of shelving includes, in series (from left to right), and aligned in end-to-end relation, a third shelf, a first shelf, and a second shelf and suggesting that the shelves in the third level of shelving are mounted on a horizontal first shelf-support tube in a first of the four racks and a horizontal second shelf-support tube in a second of the four racks as suggested in FIGS. 4 and 4A and also on a horizontal fourth shelf-support tube in the fourth rack and on a horizontal third shelf-support tube in the third rack;

FIG. 2 is a diagrammatic plan view of the third level of shelving and the four racks shown in FIG. 1 and showing the sequence of the four racks and three shelves that is used in the description provided herein and showing that the first shelf includes two cantilevered panel-support mounts that extend to the right and engage a horizontal first shelf-support tube (represented by a broken line) included in the first rack and that the second shelf includes two cantilevered panel-support mounts that extend to the left and also engage the shared horizontal first shelf-support tube without overlapping either of the two cantilevered panel-support mounts included in the first shelf;

FIG. 3A is an enlarged perspective view of the first shelf in the third level of shelving shown in FIG. 1 and suggested in FIG. 2 and showing that the first shelf includes an article-support panel, two cantilevered panel-support mounts coupled to a first (right-side) end of the panel, and two cantilevered panel-support mounts coupled to an opposite second (left-side) end of the panel;

FIG. 3B is a top plan view of the first shelf shown in FIG. 3A showing that the panel has a first side edge “below” an opposite second side edge, an inner first panel-support mount (in a lower right corner) that is offset a distance (d) from the nearby first side edge of the panel, an outer first panel-support mount (in an upper right corner) that is adjacent to the nearby second side edge of the panel, an inner second panel-support mount (in an upper left corner) that is offset a distance (D) from the nearby second side edge of the panel, and an outer second panel-support mount (in a lower left corner) that is adjacent to the nearby first side edge of the panel;

FIG. 3C is a front side elevation view of the first shelf of FIG. 3B showing that the article-support panel is arranged to interconnect the inner first panel-support mount (on the right) and the outer second panel-support mount (on the left);

FIG. 3D is an enlarged side elevation view of an inner first panel-support mount taken from the circled region of FIG. 3A showing that such mount is configured to mate with an outer surface of the first shelf-support tube included in the first rack as suggested in FIGS. 4 and 4A and that such mount includes a cantilevered horizontal plate and a vertical plate coupled to a free end of the horizontal plate;

FIG. 4 is an exploded perspective assembly view of a portion of the third shelving level of FIG. 1 suggesting engagement of the cantilevered first inner and outer panel-support mounts of the first shelf and the cantilevered second inner and outer panel-support mounts of the second shelf on a shared first shelf-support tube included in the first rack without causing any of the panel-support mounts of the first shelf to overlap a panel-support mount of the second shelf and suggesting that the first shelf-support has a near first-end section, a far second-end section, and a relatively wider middle section interconnecting the first-end and second-end sections;

FIG. 4A is an enlarged perspective assembly view taken from a circled region of FIG. 4 and suggesting engagement of the inner first panel-support mount of the first shelf with the first-end section of the first shelf-support tube of the first rack;

FIG. 5 is a perspective view of a left-side portion of the storage unit without any shelving and showing the second rack (on the right), the third rack (on the left), and a foldable rack mover interconnecting rear legs included in the second and third racks;

FIG. 6 is a top plan view of the storage unit of FIG. 1 after removal of the fourth level of shelving to show the third, first, and second shelves included in the third level of shelving;

FIG. 7 is an enlarged plan view of a first circled region shown in FIG. 6 showing side-by-side positioning of the inner first panel-support mount of the first shelf alongside the outer second panel-support mount of the second shelf in a location near to the first side edges of the first and second shelves;

FIG. 8 is an enlarged plan view of a second circled region shown in FIG. 6 showing side-by-side positioning of the outer first panel-support mount of the first shelf alongside the inner second panel-support mount of the second shelf in a location near to the second side edges of the first and second shelves;

FIGS. 9-11 show unfolding of a left-side portion of the storage unit of FIG. 1 before any shelves are mounted thereon;

FIG. 12 shows the left-side portion of the storage unit of FIG. 1 after shelves are mounted on the racks included in that left-side portion;

FIG. 13 is a perspective view of another embodiment of a storage unit in accordance with the present disclosure;

FIG. 14 is a perspective view of yet another embodiment of a storage unit in accordance with the present disclosure;

FIG. 15 is a perspective view of still another embodiment of a storage unit in accordance with the present disclosure;

FIG. 16 is a perspective view of another embodiment of a storage unit in accordance with the present disclosure; and

FIG. 17 is a perspective view of yet another embodiment of a storage unit in accordance with the present disclosure.

### DETAILED DESCRIPTION

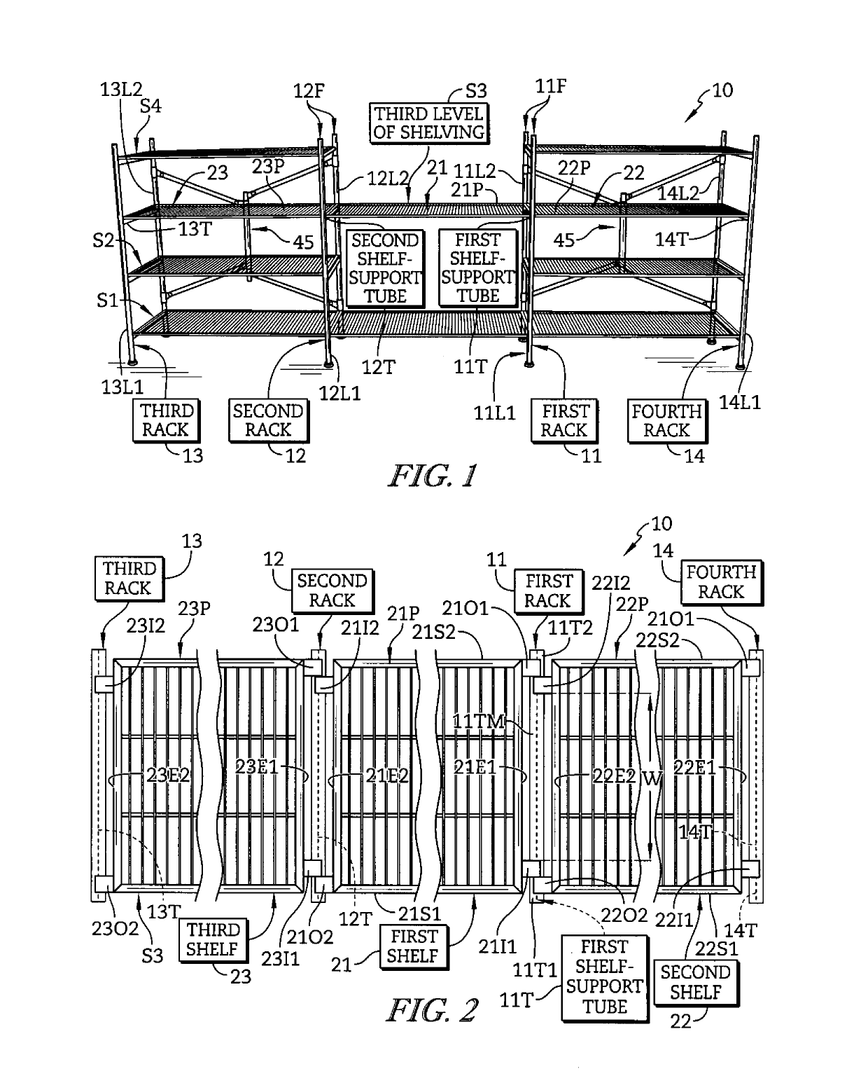

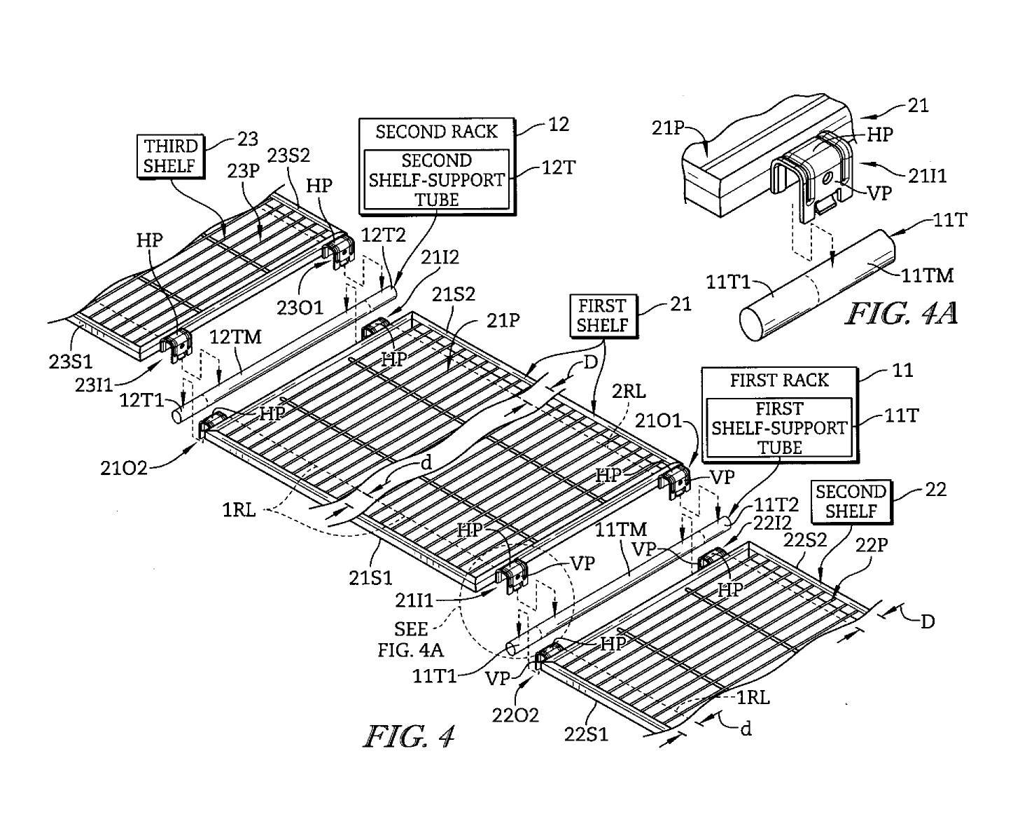

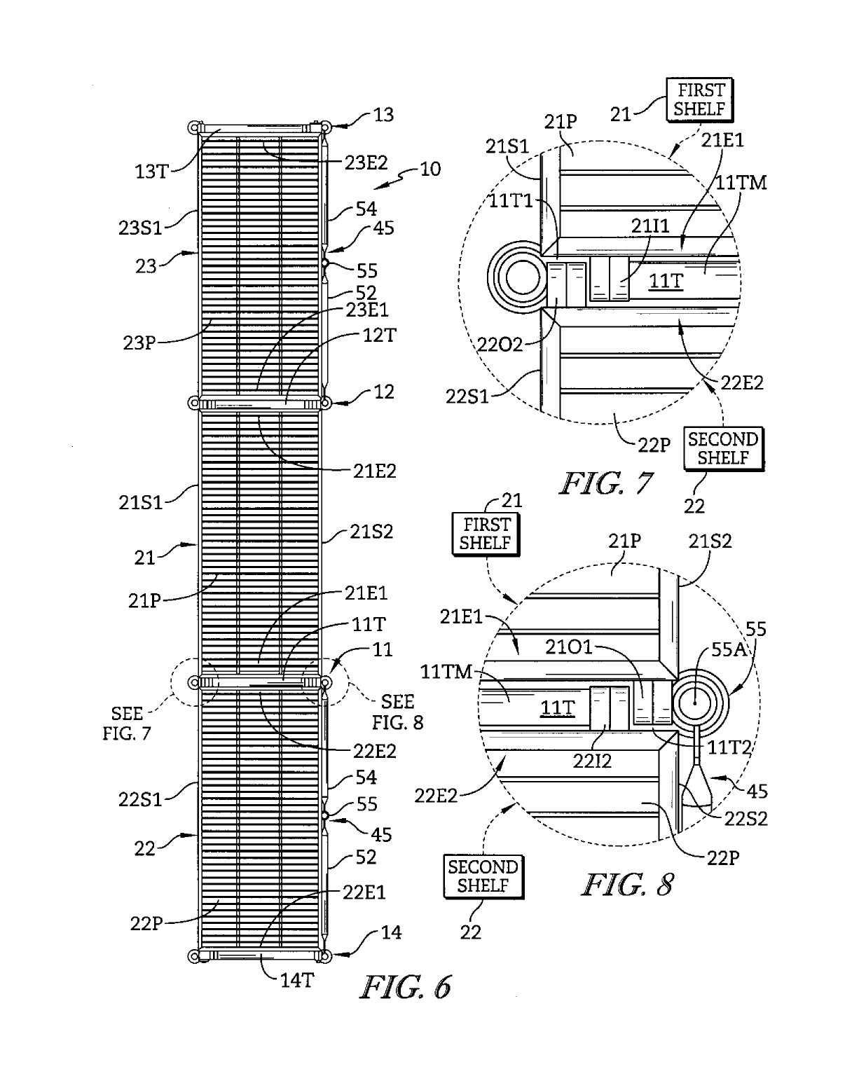

A storage unit 10 in accordance with a first embodiment of the present disclosure is shown in FIG. 1 to include four racks 11, 12, 13, and 14 and four levels of shelving S1, S2, S3, and S4. Each pair of adjacent shelves in a shelving level is coupled to a shared shelf-support tube included in a rack shared by the shelves as suggested in FIG. 1. As suggested diagrammatically in FIG. 2 with reference to the third level of shelving S3, the panel-support mounts of one shelf and the panel-support mounts of a companion adjacent shelf are coupled to the shared shelf-support tube as suggested in FIG. 4 and arranged to lie in an alternating series on and along the length of the shared shelf-support tube without overlapping one another as suggested diagrammatically in FIG. 2 and illustratively in FIG. 6.

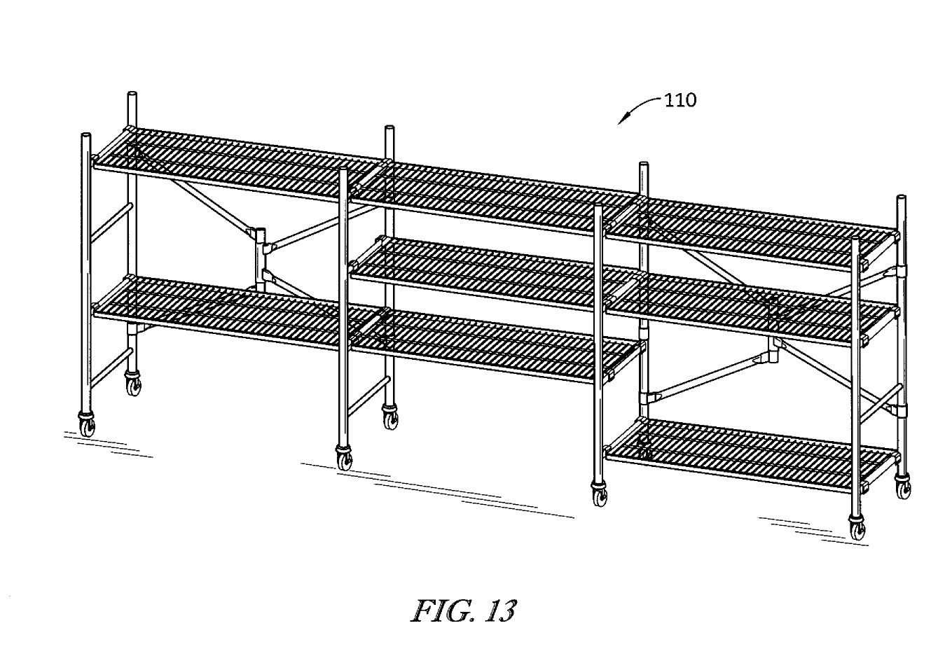

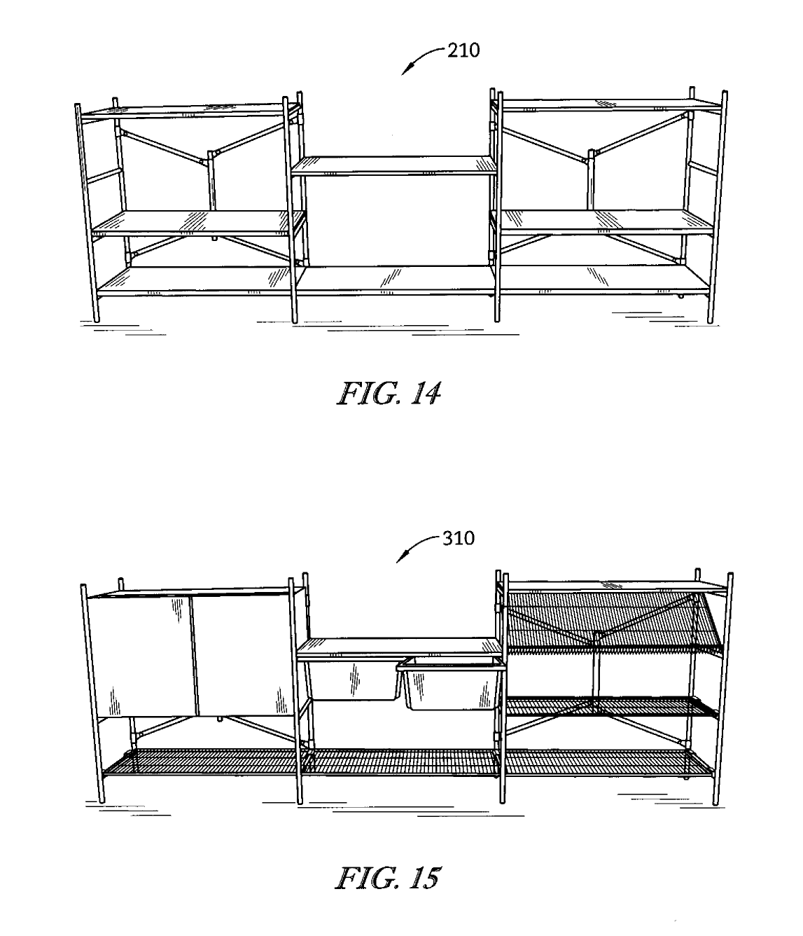

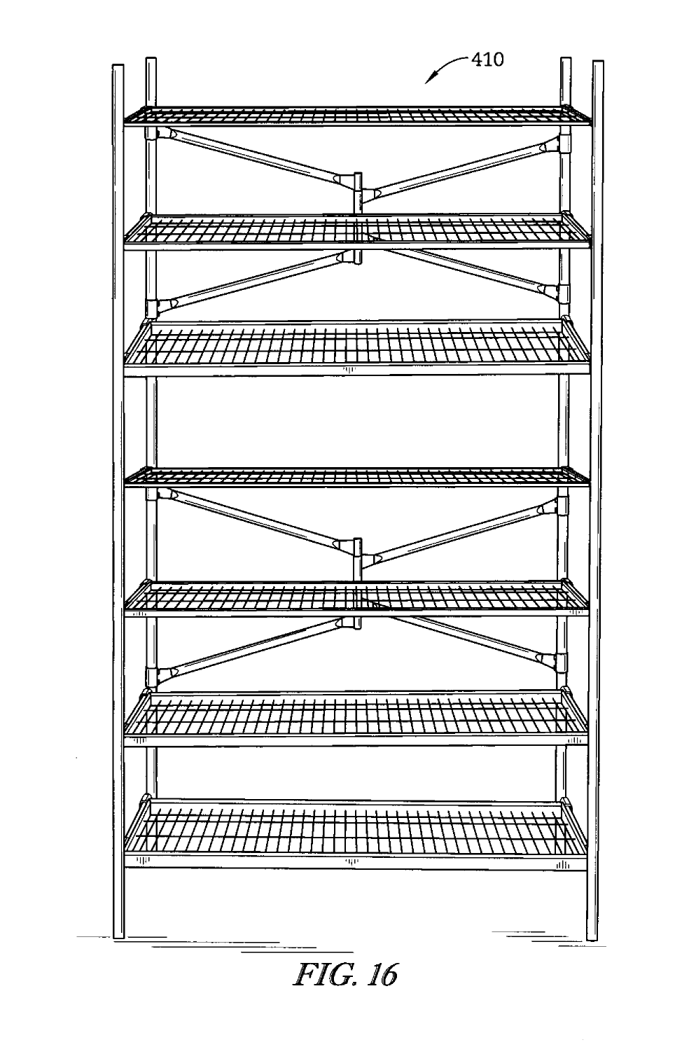

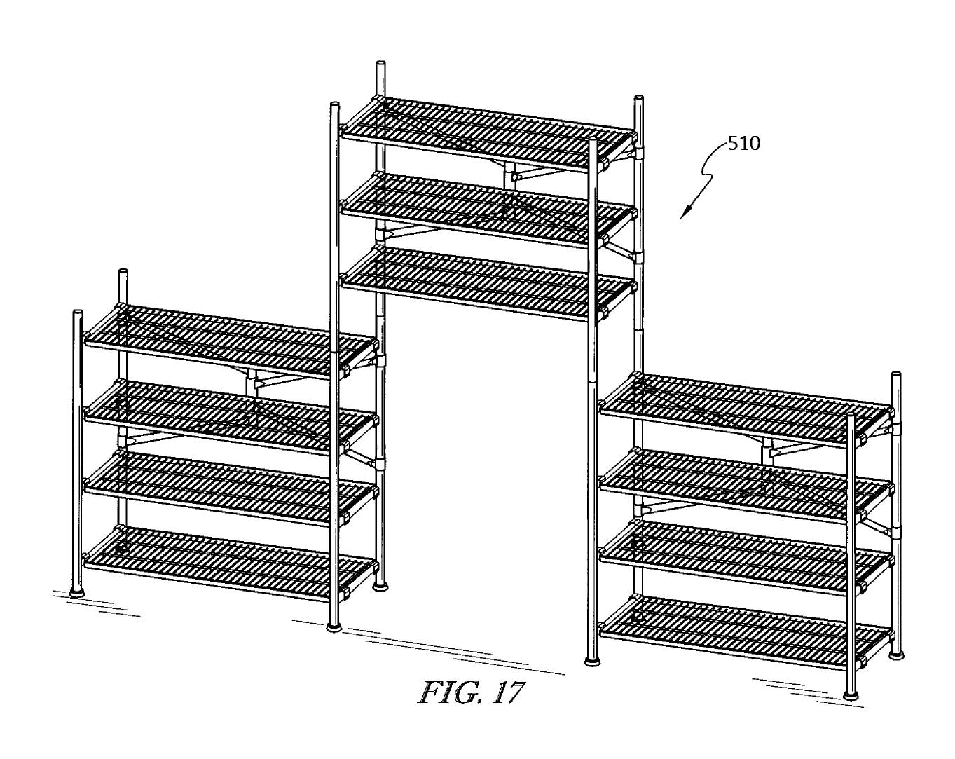

Storage unit 10 comprises a shelf-support system and shelving mounted on the shelf-support system as suggested in FIGS. 1 and 2. Storage unit 10 is modular and adjacent pairs of racks included in the unit are foldable and can be unfolded easily by a consumer as suggested in FIGS. 9-12. Alternative shelf-support systems and shelving are shown in FIGS. 13-17.

The shelf-support system of storage unit 10 includes a first rack 11, a second rack 12, a third rack 13, and a fourth rack 14 as suggested in FIGS. 1 and 2. Second rack 12 is arranged to lie between and in spaced-apart relation to each of the third and first racks 13, 11. First rack 11 is arranged to lie between and in spaced-apart relation to each of the second and fourth racks 12, 14. Each of the racks 11, 12, 13, 14 includes a shelf-support tube for each shelving level as suggested in FIG. 1.

In an illustrative embodiment, each rack in storage unit 10 includes first and second vertical legs that cooperate to define an upright tube-support frame and four horizontal shelf-support tubes that are arranged to interconnect those first and second vertical legs and to engage and support the shelving as suggested in FIG. 1. First rack 11 includes legs 11L1, 11L2 and a series of vertically spaced-apart shelf-support tubes including a first shelf-support tube 11T associated with shelving level S3. Second rack 12 includes legs 12L1, 12L2 and a series of vertically spaced-apart shelf-support tubes including a second shelf-support tube 12T associated with shelving level S3. Third rack 13 includes legs 13L1, 13L2 and a series of vertically spaced-apart shelf-support tubes including a third shelf-support tube 13T associated with shelving level S3. Fourth rack 14 includes legs 14L1, 14L2 and a series of vertically spaced-apart shelf-support tubes including a fourth shelf-support tube 14T associated with shelving level S3. Each shelf-support tube can have any suitable size and shape.

The shelving of storage unit 10 is mounted on the first, second, third, and fourth racks 11, 12, 13, 14 to lie at predetermined elevations above ground underlying the racks as suggested in FIG. 1. The shelving in the third shelving level S3 includes, in series, a third shelf 23 coupled to the third and second racks 13, 12, a first shelf 21 coupled to the second and first racks 12, 11, and a second shelf 22 coupled to the first and fourth racks 11, 14.

First shelf 21 includes an article-support panel 21P having a first end 21E1 and an opposite second end 21E2 as suggested in FIG. 2. A pair of inner and outer first panel-support mounts 21I1, 21O1 is coupled to first end 21E1 of the article-support panel 21P and arranged to engage first shelf-support tube 11T of first rack 11. A pair of inner and outer second panel-support mounts 21I2, 21O2 is coupled to an opposite second end 21E2 of the article-support panel 21P and arranged to lie in spaced-apart relation to the pair of inner and outer first panel-support mounts 21I2, 21O2 to locate the article-support panel 21P therebetween and to engage second shelf-support tube 12T of second rack 12.

Second shelf 22 includes an article-support panel 22P having a first end 22E1 and an opposite second end 22E2 as suggested in FIG. 2. A pair of inner and outer first panel-support mounts 22I1, 22O1 is coupled to first end 22E1 of the article-support panel 22P and arranged to engage fourth shelf-support tube 14T of fourth rack 14. A pair of inner and outer second panel-support mounts 22I2, 22O2 is coupled to an opposite second end 22E2 of the article-support panel 22P and arranged to lie in spaced-apart relation to the pair of inner and outer first panel-support mounts 22I1, 22O1 to locate the article-support panel 22P therebetween and to engage first shelf-support tube 11T of first rack 11.

Third shelf 23 includes an article-support panel 23P having a first end 23E1 and an opposite second end 23E2 as suggested in FIG. 2. A pair of inner and outer first panel-support mounts 23I1, 23O1 is coupled to first end 23E1 of the article-support panel 23F and arranged to engage second shelf-support tube 12T of second rack 12. A pair of inner and outer second panel-support mounts 23I2, 23O2 is coupled to an opposite second end 23E2 of the article-support panel 23P and arranged to lie in spaced-apart relation to the pair of inner and outer first panel-support mounts 23I1, 23O1 to locate the article-support panel 23P therebetween and to engage third shelf-support tube 13T of third rack 13.

First shelf-support tube 11T of the first rack 11 is arranged to lie between the article-support panels 21P, 22P of the first and second shelves 21, 22 as suggested in FIGS. 1, 2, and 6. Outer second panel-support mount 22O2 of the second shelf 22, inner first panel-support mount 21I1 of the first shelf 21, inner second panel-support mount 22I2 of the second shelf 22, and outer first panel-support mount 21O1 of first shelf 21 are arranged to engage first shelf-support tube 11T of first rack 11 and lie in series along a length of the first shelf-support tube 11T of the first rack 11 as suggested in FIGS. 2 and 6.

Second shelf-support tube 12T of the second rack 12 is arranged to lie between the article-support panels 23P, 21P of the third and first shelves 23, 21 as suggested in FIGS. 1, 2, and 6. Outer second panel-support mount 21O2 of the first shelf 21, inner first panel-support mount 23I1 of the third shelf 23, inner second panel-support mount 21I2 of the first shelf 21, and outer first panel-support mount 23O1 of the third shelf 23 are arranged to engage the second shelf-support tube 12T of the second rack 12 and lie in series along a length of the second shelf-support tube 12T of the second rack 12 as suggested in FIGS. 2 and 6.

The inner and outer first panel-support mounts 22I1, 22O1 of the second shelf 22 are coupled to the fourth shelf-support tube 14T of the fourth rack 14 as suggested in FIGS. 2 and 6. The inner and outer second panel-support mounts 23I2, 23O2 of the third shelf 23 are coupled to the third shelf-support tube 13T of the third rack 13 as suggested in FIGS. 2 and 6.

Storage unit 10 comprises first and second racks 11, 12 and a third shelving level S3 including first and second shelves 21, 22 as suggested in FIGS. 1 and 2. First rack 11 includes an upright first tube-support frame 11F and a first shelf-support tube 11T coupled to the upright first tube-support frame 11F. Second rack 12 includes an upright second tube-support frame 12F and a second shelf-support tube 12T coupled to the upright second tube-support frame 12F and arranged to lie in spaced-apart relation to the first shelf-support tube 11T as suggested in FIGS. 1 and 2.

First shelf 21 is formed to include an article-support panel 21P arranged to lie between the first and second shelf-support tubes 11T, 12T, an inner first panel-support mount 21I1, and an outer first panel-support mount 21O1 as suggested in FIG. 2. Article-support panel 21P has a first end 21E1 associated with the first shelf-support tube 11T and coupled to each of the inner and outer first panel-support mounts 21I1, 21O1 and an opposite second end 21E2 associated with the second shelf-support tube 12T. Article-support panel 21P also has a first side edge 21S1 arranged to extend between the first and second ends 21E1, 21E2 and an opposite second side edge 21S2 arranged to extend between the first and second ends 2E1, 21E2 and lie in spaced-apart relation to the first side edge 21S1.

Second shelf 22 is formed to include an article-support panel 22P arranged to lie in spaced-apart relation to the article-support panel 21P of the first shelf 21 to locate the first shelf-support tube 11T therebetween, an inner second panel-support mount 22I2, and an outer second panel-support mount 22O2. Article-support panel 22P of the second shelf 22 has a second end 22E1 associated with the first shelf-support tube 11T and coupled to each of the inner and outer second panel-support mounts 22I2, 22O2, a first side edge 22S1 associated with the first side edge 21S1 of the first shelf 21, and an opposite second side edge 22S2 arranged to extend between the first and second ends 22E1, 22E2 and lie in spaced-apart relation to the first side edge 22S1.

First shelf-support tube 11T includes a first-end section 11T1 coupled to the upright first tube-support frame 11F, an opposite second-end section 11T2 coupled to the upright first tube-support frame 11F, and a middle section 11TM arranged to interconnect the first-end and second-end sections 11T1, 11T2 as suggested in FIG. 4. Middle section 11TM is much wider than each of first-end and second-end sections 11T1, 11T2 as shown, for example, in FIG. 4.

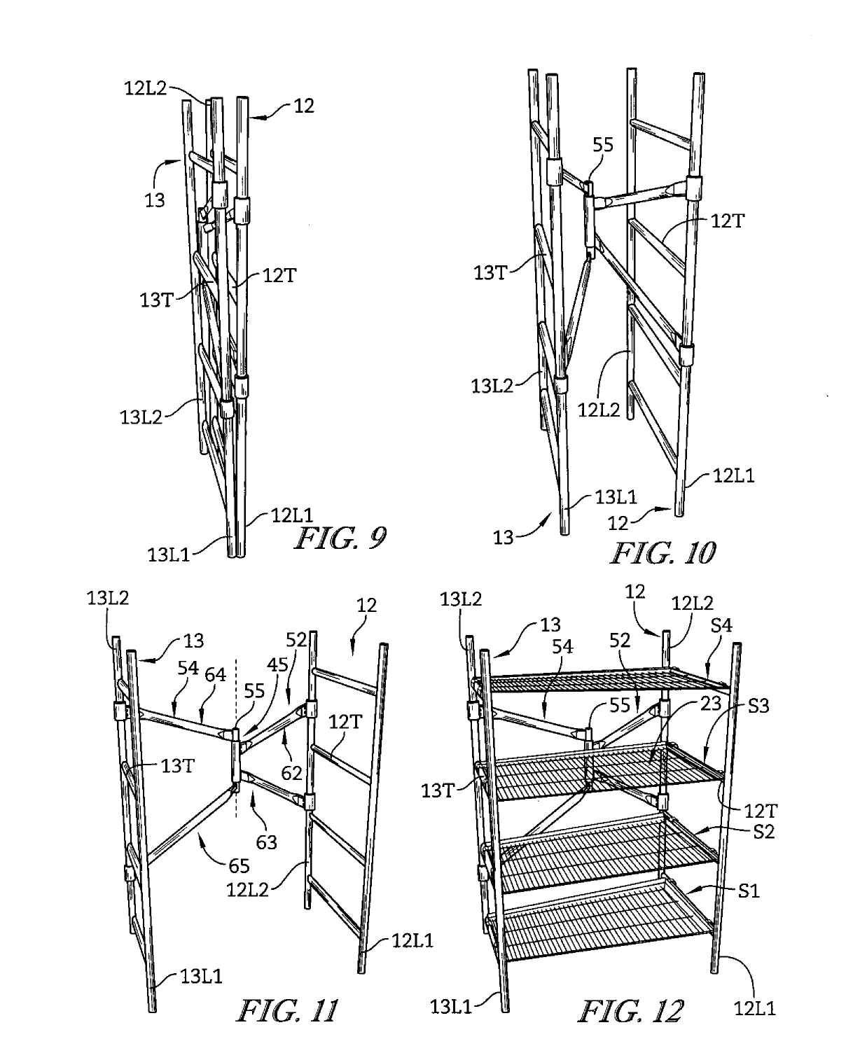

Inner first panel-support mount 21I1 of the first shelf 21 is arranged to engage the middle section 11TM of the first shelf-support tube 11T as suggested in FIGS. 2, 4, and 7. Outer first panel-support mount 21O1 of the first shelf 21 is arranged to engage the second-end section 11T2 of the first shelf-support tube 11T as suggested in FIGS. 2, 4, and 8.

Outer second panel-support mount 22O2 of the second shelf 22 is arranged to engage the first-end section 11T1 of the first shelf-support tube 11T as suggested in FIGS. 2, 4, and 7. Inner second panel-support mount 22I2 of the second shelf 22 is arranged to engage the middle section 11TM of the first shelf-support tube 11T as suggested in FIGS. 2, 4, and 7 so that the outer second panel-support mount 22O2 of the second shelf 22, inner first panel-support mount 21I1 of the first shelf 21, inner second panel-support mount 22I2 of the second shelf 22, and outer first panel-support mount 21O1 of the first shelf 21 are arranged to engage first shelf-support tube 11T and lie in series along a length of the first shelf-support tube 11T as suggested in FIGS. 2 and 4.

Outer second panel-support mount 2202 of the second shelf 22 and the inner first panel-support mount 22I1 of the first shelf 21 are arranged to lie in side-by-side relation to one another as suggested in FIGS. 2, 6, and 7. Inner second panel-support mount 22I2 of the second shelf 22 and the outer first panel-support mount 21O1 of the first shelf 11 are arranged to lie in side-by-side relation to one another as suggested in FIGS. 2, 6, and 8 to cause the inner second panel-support mount 22I2 of the second shelf 22 to lie in spaced-apart relation to the inner first panel-support mount 22I1 of the first shelf 21 as suggested in FIGS. 2 and 4.

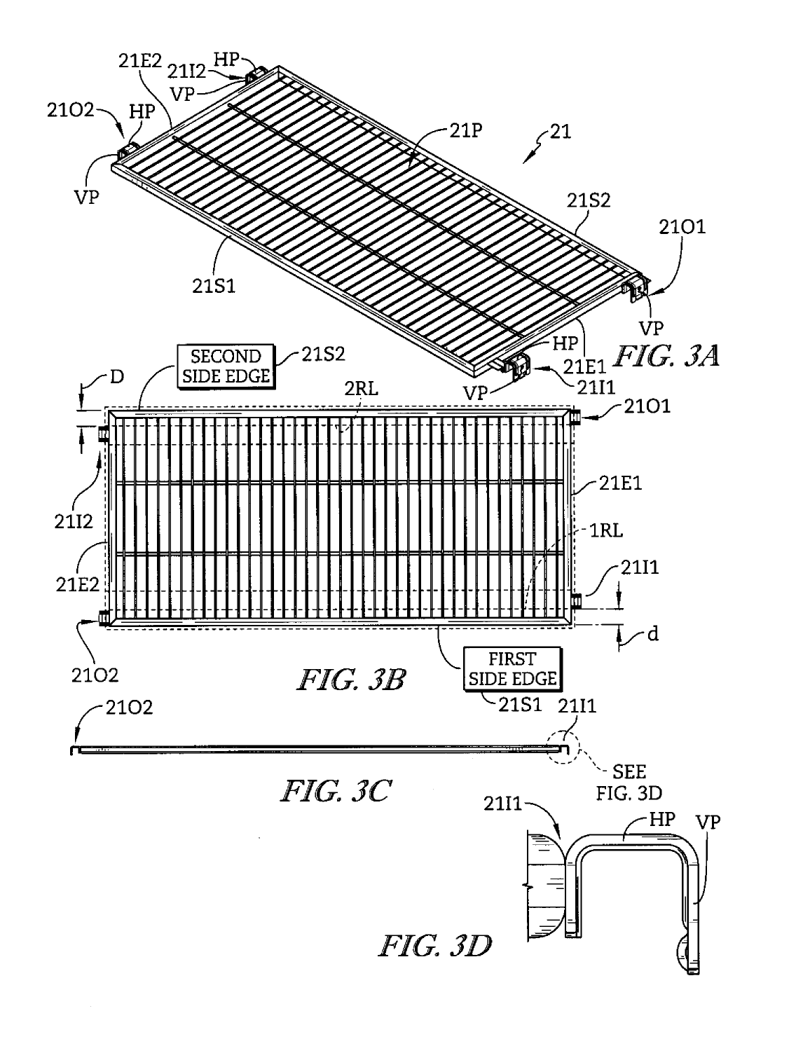

Article-support panels 21P, 22P of the first and second shelves 21, 22 are aligned in end-to-end relation to one another as suggested in FIGS. 2 and 6 (1) to locate inner and outer first and second panel-support mounts 22O2, 21I1, 22I2, 21O1 therebetween and (2) to align the first side edges 21S1, 22S1 of each of the first and second shelves 21, 22 in substantially collinear relation to one another. Inner first panel-support mount 21I1 of the first shelf 21 is offset to lie a distance (d) from the first side edge 21S1 of the article-support panel 21P of the first shelf 21 as suggested in FIGS. 3B and 4. Outer second panel-support mount 22O2 of the second shelf 22 is adjacent to the first side edge 22S1 of the article-support panel 22P of the second shelf 22 to lie within a space defined between a first reference line 1RL that is arranged to lie in generally parallel relation to the first side edge 22S1 of the second shelf 12 and separated from the first side edge of the second shelf 22 by the distance (d).

Inner first panel-support mount 21I1 of first shelf 21 includes a first horizontal plate HP arranged to overlie the first shelf-support tube 11T1. Outer second panel-support mount 2202 of second shelf 22 includes a second horizontal plate HP arranged to overlie the first shelf-support tube 11T and lie in substantially coplanar relation to the first horizontal plate HP of the neighboring inner first panel-support mount 21I1.

Inner first panel-support mount 21I1 further includes a first vertical plate VP coupled to a free end of the first horizontal plate HP and arranged to extend downwardly to lie between the first shelf-support tube 11T and the second end 22E2 of the article-support panel 22P of the second shelf 22 as suggested in FIG. 4. Outer second panel-support mount 22O2 further includes a second vertical plate VP coupled to a free end of the second horizontal plate HP and arranged to extend downwardly to lie between the first shelf-support tube 11T and the first end 21E of the article-support panel 21P of the first shelf 21 as also suggested in FIG. 4.

Second side edges 21S1, 22S2 of each of the first and second shelves 21, 22 are aligned to lie in substantially collinear relation to one another as suggested in FIGS. 2 and 6. Inner second panel-support mount 22I2 of the second shelf 12 is offset to lie a distance (D) from the second side edge 22S2 of the article-support panel 22P of the second shelf 22. Outer first panel-support mount 21O1 of the first shelf 21 is adjacent to the second side edge 21S2 of the article-support panel 21P of the first shelf 21 to lie within a space defined between a second reference line 2RL that is arranged to lie in generally parallel relation to the second side edge 21S1 of the first shelf 21 and separated from the second side edge 21S2 of the first shelf 21 by the distance (D). The distance (d) is about equal to the distance (D) in illustrative embodiments. The inner first and second panel-support mounts 21I1, 22I2 are separated by a width (W) as suggested in FIG. 2 that is greater than the distance (d) multiplied by three.

The upright first tube-support frame 11F of the first rack 11 includes a vertical first leg 11L1 and a vertical second leg 11L2 arranged to lie in spaced-apart parallel relation to the vertical first leg 11L1 as suggested in FIG. 1. First-end section 11T1 of the first shelf-support tube 11T is coupled to the vertical first leg 11L1. Second-end section 11T2 of the first shelf-support tube 11T is coupled to the vertical second leg 11L2. The inner and outer first panel-support mounts 21I1, 21O1 of the first shelf 21 and the inner and outer second panel-support mounts 22I2, 22O2 of the second shelf 22 are arranged on the first shelf-support tube 11T to engage on and lie between the vertical first and second legs 11L1, 11L2 of the upright tube-support frame 11F of the first rack 11.

Third shelf 23 is formed to include an article-support panel 23P arranged to lie in spaced-apart relation to the article-support panel 21P of the first shelf 21 to locate the second shelf-support tube 12T therebetween. First shelf 21 further includes an outer second panel-support mount 21O2 and an inner second panel-support mount 21I2. Second end 21E2 of the article-support panel 21P of the first shelf 21 is coupled to each of the outer and inner second panel-support mounts 21O2, 21I2 of the first shelf 21.

Second shelf-support tube 12T includes a first-end section 12T1 coupled to the upright second tube-support frame 12F of the second rack 12, an opposite second-end section 12T2 coupled to the upright second tube-support frame 12F of the second rack 12, and a middle section 12TM arranged to interconnect the first-end and second-end sections 12T1, 12T2 of the second shelf-support tube 12T. Outer second panel-support mount 21O2 of the first shelf 21 is arranged to engage the first-end section 12T1 of the second shelf-support tube 12T. Inner second panel-support mount 21I2 of the first shelf 21 is arranged to engage the middle section 23TM of the second shelf-support tube 12T.

Article-support panel 23P of the third shelf 23 has a first end 23E1 associated with the second shelf-support tube 12T and a first side edge 23S1 associated with the first side edge 21S1 of the first shelf 21. Third shelf 23 further includes an inner first panel-support mount 23I1 coupled to the first end 23E1 of the article-support panel 23P of the third shelf 23 and an outer first panel-support mount 23O1 coupled to the first end 23E1 of the article-support panel 23P of the third shelf 23. Inner first panel-support mount 23I1 of the third shelf 23 is arranged to engage the middle section 22TM of the second shelf-support tube 12T. Outer first panel-support mount 23O1 of the third shelf 23 is arranged to engage the second-end section 12E2 of the second shelf-support tube 12T so that the outer second panel-support mount 21O2 of the first shelf 21, inner first panel-support mount 23I1 of the third shelf 23, inner second panel-support mount 21I2 of the first shelf 21, and outer first panel-support mount 23O1 of the third shelf 23 are arranged to engage on and lie in series along a length of the second shelf-support tube 12T.

The article-support panels 23P, 21P of the third and first shelves 23, 21 are aligned in end-to-end relation to one another (1) to locate inner and outer first panel-support mounts 23I1, 23O1 of the third shelf 23 and the inner and outer second panel-support mounts 21I2, 21O2 of the first shelf 21 therebetween and (2) to align the first side edges 21S1, 23S1 of each of the third and first shelves 23, 21 in substantially collinear relation to one another. Inner first panel-support mount 23I1 of the third shelf 23 is offset to lie a distance (d) from the first side edge 23S1 of the article-support panel 23P of the third shelf 23. Outer second panel-support mount 21O2 of the first shelf 21 is adjacent to the first side edge 21S1 of the article-support panel 21P of the first shelf 21 to lie within a space defined between a first reference line 1RL that is arranged to lie in generally parallel relation to the first side edge 21S1 of the first shelf 21 and separated from the first side edge 21S1 of the first shelf 21 by the distance (d).

Inner first panel-support mount 23I1 of the third shelf 23 includes a first horizontal plate HP arranged to overlie the second shelf-support tube 12T as suggested in FIG. 4. Outer second panel-support mount of the first shelf 21 includes a second horizontal plate HP arranged to overlie the second shelf-support tube 12T and lie in substantially coplanar relation to the first horizontal plate HP of the inner first panel-support mount 23I1 of the third shelf 23. Inner first panel-support mount 23I1 of the third shelf 23 further includes a first vertical plate VP coupled to a free end of the first horizontal plate HP and arranged to extend downwardly to lie between the second shelf-support tube 12T and the second end 21E1 of the article-support panel 21P of the first shelf 21. Outer second panel-support mount 21O2 of the first shelf 21 further includes a second vertical plate VP coupled to a free end of the second horizontal plate HP and arranged to extend downwardly to lie between the second shelf-support tube 12T and the first end 23E1 of the article-support panel 23P of the third shelf 23.

Inner second panel-support mount 21I2 of the first shelf 21 and the outer first panel-support mount 23O1 of the third shelf 23 are arranged to lie in side-by-side relation to one another. This arrangement causes the inner second panel-support mount 21I2 of the first shelf 21 to lie in spaced-apart relation to the inner first panel-support mount 23I1 of the third shelf 23.

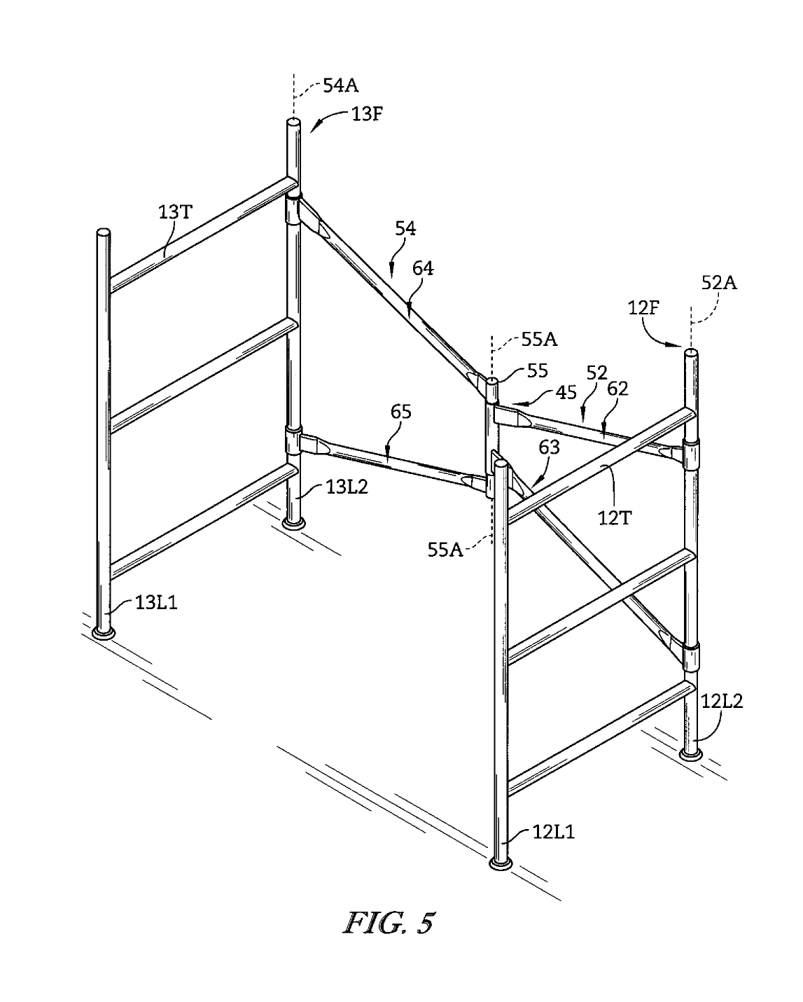

A rack mover 45 illustratively includes a right pivot link 52 and a left pivot link 54 coupled to right pivot link 52 for pivotable movement about pivot axis 55A as shown in FIG. 5. The rack mover 45 extends from the rear upright 48 of the right frame 42 to rear upright 58 of the left frame 44 so that the right frame 42 and the left frame 44 can move relative to one another from a collapsed storage position to an expanded use position as suggested in FIGS. 9-12. The right pivot link 52 is coupled to the vertical seam by 12L2 of the right frame 42 for rotation about an axis 52A that extends along the leg 12L2. The left pivot link 54 is coupled to the vertical second leg 13L2 of the left frame 44 for rotation about an axis 54A that extends along the leg 13L2. The right pivot link 52 is also coupled to the left pivot link 54 to form a pivot joint 55 that allows the right and left pivot links 52, 54 to pivot relative to one another about a pivot axis 55A that is spaced apart from and parallel to the axes 52A and 54A. The rack mover 45 provides means for allowing quick folding and unfolding of the foldable unit so that the shelving units are easy to assemble.

The right pivot link 52 of the rack mover 45 includes an upper bar 62, a lower bar 63, and a joint bar 53 as shown, for example, in FIG. 5. The upper bar 62 extends downwardly at an acute angle from the leg 12L2 toward the pivot joint 55. The lower bar 63 extends upwardly at an acute angle from the leg 12L2 toward the pivot joint 55. The joint bar 53 interconnects the upper bar 62 and the lower bar 63 and extends along the pivot axis 55A.

The left pivot link 54 of the rack mover 45 includes an upper bar 64, a lower bar 65, and a joint bar 57 as shown in FIG. 5. The upper bar 64 extends downwardly at an acute angle from the rear upright 58 toward the pivot joint 55. The lower bar 65 extends upwardly at an acute angle from the rear upright 58 toward the pivot joint 55. The joint bar 57 interconnects the upper bar 64 and the lower bar 65 and extends along the pivot axis 55A.

The arrangement of the bars 62, 63, 64, 65 result in a lack of horizontal members that extend from the right frame 42 to the left frame 44 as shown in FIG. 5. Thus, items stored on a top shelf of the shelving units or under a bottom shelf of the shelving units can be pushed all the way to a wall behind the shelving units as suggested in FIG. 1.

Alternative modular storage units 110, 210, 310, 410, 510 are shown in FIGS. 13-17. Each alternative modular storage unit 110, 210, 310, 410, 510 is substantially similar to the modular storage unit 10 shown in FIGS. 1-12.

1. A storage unit comprising
a first rack including an upright first tube-support frame and a first shelf-support tube coupled to the upright first tube-support frame,
a second rack including an upright second tube-support frame and a second shelf-support tube coupled to the upright second tube-support frame and arranged to lie in spaced-apart relation to the first shelf-support tube, and
shelving mounted on the first and second shelf-support tubes, the shelving including a first shelf formed to include an article-support panel arranged to lie between the first and second shelf-support tubes, an inner first panel-support mount, and an outer first panel-support mount, the article-support panel having a first end associated with the first shelf-support tube and coupled to each of the inner and outer first panel-support mounts and an opposite second end associated with the second shelf-support tube, a first side edge arranged to extend between the first and second ends, and an opposite second side edge arranged to extend between the first and second ends and lie in spaced-apart relation to the first side edge, the shelving further including a second shelf formed to include an article-support panel arranged to lie in spaced-apart relation to the article-support panel of the first shelf to locate the first shelf-support tube therebetween, an inner second panel-support mount, and an outer second panel-support mount, the article-support panel of the second shelf having a second end associated with the first shelf-support tube and coupled to each of the inner and outer second panel-support mounts and a first side edge associated with the first side edge of the first shelf, and
wherein the first shelf-support tube includes a first-end section coupled to the upright first tube-support frame, an opposite second-end section coupled to the upright first tube-support frame, and a middle section arranged to interconnect the first-end and second-end sections,
wherein the inner first panel-support mount of the first shelf is arranged to engage the middle section of the first shelf-support tube, and the outer first panel-support mount of the first shelf is arranged to engage the second-end section of the first shelf-support tube, and
wherein the outer second panel-support mount of the second shelf is arranged to engage the first-end section of the first shelf-support tube and the inner second panel-support mount of the second shelf is arranged to engage the middle section of the first shelf-support tube so that the outer second panel-support mount of the second shelf, inner first panel-support mount of the first shelf, inner second panel-support mount of the second shelf, and outer first panel-support mount of the first shelf are arranged to lie in series along a length of the first shelf-support tube.

2. The storage unit of claim 1, wherein the outer second panel-support mount of the second shelf and the inner first panel-support mount of the first shelf are arranged to lie in side-by-side relation to one another.

3. The storage unit of claim 2, wherein the article-support panels of the first and second shelves are aligned in end-to-end relation to one another to locate inner and outer first and second panel-support mounts therebetween and to align the first side edges of each of the first and second shelves in substantially collinear relation to one another, the inner first panel-support mount of the first shelf is offset to lie a distance (d) from the first side edge of the article-support panel of the first shelf, and the outer second panel-support mount of the second shelf is adjacent to the first side edge of the article-support panel of the second shelf to lie within a space defined between a first reference line that is arranged to lie in generally parallel relation to the first side edge of the second shelf and separated from the first side edge of the second shelf by the distance (d).

4. The storage unit of claim 3, wherein the inner first panel-support mount includes a first horizontal plate arranged to overlie the first shelf-support tube and the outer second panel-support mount includes a second horizontal plate arranged to overlie the first shelf-support tube and lie in substantially coplanar relation to the first horizontal plate of the inner first panel-support mount.

5. The storage unit of claim 4, wherein the inner first panel-support mount further includes a first vertical plate coupled to a free end of the first horizontal plate and arranged to extend downwardly to lie between the first shelf-support tube and the second end of the article-support panel of the second shelf.

6. The storage unit of claim 5, wherein the outer second panel-support mount further includes a second vertical plate coupled to a free end of the second horizontal plate and arranged to extend downwardly to lie between the first shelf-support tube and the first end of the article-support panel of the first shelf.

7. The storage unit of claim 4, wherein the outer second panel-support mount further includes a second vertical plate coupled to a free end of the second horizontal plate and arranged to extend downwardly to lie between the first shelf-support tube and the first end of the article-support panel of the first shelf.

8. The storage unit of claim 2, wherein the inner second panel-support mount of the second shelf and the outer first panel-support mount of the first shelf are arranged to lie in side-by-side relation to one another to cause the inner second panel-support mount of the second shelf to lie in spaced-apart relation to the inner first panel-support mount of the first shelf.

9. The storage unit of claim 8, wherein the article-support panels of the first and second shelves are aligned in end-to-end relation to one another to locate inner and outer first and second panel-support mounts therebetween and to align the first side edges of each of the first and second shelves in substantially collinear relation to one another, the inner first panel-support mount of the first shelf is offset to lie a distance (d) from the first side edge of the article-support panel of the first shelf, the outer second panel-support mount of the second shelf is adjacent to the first side edge of the article-support panel of the second shelf to lie within a space defined between a first reference line that is arranged to lie in generally parallel relation to the first side edge of the second shelf and separated from the first side edge of the second shelf by the distance (d), the second side edges of each of the first and second shelves are aligned in substantially collinear relation to one another, the inner second panel-support mount of the second shelf is offset to lie a distance (D) from the second side edge of the article-support panel of the second shelf, the outer first panel-support mount of the first shelf is adjacent to the second side edge of the article-support panel of the first shelf to lie within a space defined between a second reference line that is arranged to lie in generally parallel relation to the second side edge of the first shelf and separated from the second side edge of the first shelf by the distance (D).

10. The storage unit of claim 9, wherein the distance (d) is about equal to the distance (D).

11. The storage unit of claim 10, wherein the inner first and second panel-support mounts are separated by a width (W) that is greater than the distance (d) multiplied by three.

12. The storage unit of claim 1, wherein the inner second panel-support mount of the second shelf and the outer first panel-support mount of the first shelf are arranged to lie in side-by-side relation to one another.

13. The storage unit of claim 12, wherein the article-support panels of the first and second shelves are aligned in end-to-end relation to one another to locate inner and outer first and second panel-support mounts therebetween and to align the second side edges of each of the first and second shelves in substantially collinear relation to one another, the inner second panel-support mount of the second shelf is offset to lie a distance (D) from the second side edge of the article-support panel of the second shelf, the outer first panel-support mount of the first shelf is adjacent to the second side edge of the article-support panel of the first shelf to lie within a space defined between a second reference line that is arranged to lie in generally parallel relation to the second side edge of the first shelf and separated from the second side edge of the first shelf by the distance (D).

14. The storage unit of claim 1, wherein the upright first tube-support frame of the first rack includes a vertical first leg and a vertical second leg arranged to lie in spaced-apart parallel relation to the vertical first leg, the first-end section of the first shelf-support tube is coupled to the vertical first leg, the second-end section of the first shelf-support tube is coupled to the vertical second leg, and the inner and outer first panel-support mounts of the first shelf and the inner and outer second panel-support mounts of the second shelf are arranged on the first shelf-support tube to lie between the vertical first and second legs of the upright tube-support frame of the first rack.

15. The storage unit of claim 1, wherein the shelving further includes a third shelf formed to include an article-support panel arranged to lie in spaced-apart relation to the article-support panel of the first shelf to locate the second shelf-support tube therebetween, the first shelf further includes an outer second panel-support mount and an inner second panel-support mount, the second end of the article-support panel of the first shelf is coupled to each of the outer and inner second panel-support mounts of the first shelf, the second shelf-support tube includes a first-end section coupled to the upright second tube-support frame of the second rack, an opposite second-end section coupled to the upright second tube-support frame of the second rack, and a middle section arranged to interconnect the first-end and second-end sections of the second shelf-support tube, the outer second panel-support mount of the first shelf is arranged to engage the first-end section of the second shelf-support tube, the inner second panel-support mount of the first shelf is arranged to engage the middle section of the second shelf-support tube, the article-support panel of the third shelf has a first end associated with the second shelf-support tube and a first side edge associated with the first side edge of the first shelf, the third shelf further includes an inner first panel-support mount coupled to the first end of the article-support panel of the third shelf and an outer first panel-support mount coupled to the first end of the article-support panel of the tird shelf, the inner first panel-support mount of the third shelf is arranged to engage the middle section of the second shelf-support tube, and the outer first panel-support mount of the third shelf is arranged to engage the second-end section of the second shelf-support tube so that the outer second panel-support mount of the first shelf, inner first panel-support mount of the third shelf, inner second panel-support mount of the first shelf, and outer first panel-support mount of the third shelf are arranged to engage on and lie in series along a length of the second shelf-support tube.

16. The storage unit of claim 15, wherein the outer second panel-support mount of the first shelf and the inner first panel-support mount of the third shelf are arranged to lie in side-by-side relation to one another.

17. The storage unit of claim 16, wherein the article-support panels of the third and first shelves are aligned in end-to-end relation to one another to locate inner and outer first panel-support mounts of the third shelf and the inner and outer second panel-support mounts of the first shelf therebetween and to align the first side edges of each of the third and first shelves in substantially collinear relation to one another, the inner first panel-support mount of the third shelf is offset to lie a distance (d) from the first side edge of the article-support panel of the third shelf, and the outer second panel-support mount of the first shelf is adjacent to the first side edge of the article-support mount of the first shelf to lie within a space defined between a first reference line that is arranged to lie in generally parallel relation to the first side edge of the first shelf and separated from the first side edge of the first shelf by the distance (d).

18. The storage unit of claim 17, wherein the inner first panel-support mount of the third shelf includes a first horizontal plate arranged to overlie the second shelf-support tube, the outer second panel-support mount of the first shelf includes a second horizontal plate arranged to overlie the second shelf-support tube and lie in substantially coplanar relation to the first horizontal plate of the inner first panel-support mount of the third shelf.

19. The storage unit of claim 18, wherein the inner first panel-support mount of the third shelf further includes a first vertical plate coupled to a free end of the first horizontal plate of the third shelf and arranged to extend downwardly to lie between the second shelf-support tube and the second end of the article-support panel of the first shelf.

20. The storage unit of claim 19, wherein the outer second panel-support mount of the first shelf further includes a second vertical plate of the first shelf coupled to a free end of the second horizontal plate of the first shelf and arranged to extend downwardly to lie between the second shelf-support tube and the first end of the article-support panel of the third shelf.

21. The storage unit of claim 18, wherein the outer second panel-support mount of the first shelf further includes a second vertical plate coupled to a free end of the second horizontal plate of the first shelf and arranged to extend downwardly to lie between the second shelf-support tube and the first end of the article-support panel of the third shelf.

22. The storage unit of claim 16, wherein the inner second panel-support mount of the first shelf and the outer first panel-support mount of the third shelf are arranged to lie in side-by-side relation to one another to cause the inner second panel-support mount of the first shelf to lie in spaced-apart relation to the inner first panel-support mount of the third shelf.

23. The storage unit of claim 22, wherein the article-support panels of the third and first shelves are aligned in end-to-end relation to one another to locate inner and outer first and second panel-support mounts therebetween and to align the first side edges of each of the third and first shelves in substantially collinear relation to one another, the inner first panel-support mount of the third shelf is offset to lie a distance (d) from the first side edge of the article-support panel of the third shelf, the outer second panel-support mount of the first shelf is adjacent to the first side edge of the article-support panel of the first shelf to lie within a space defined between a first reference line that is arranged to lie in generally parallel relation to the first side edge of the first shelf and separated from the first side edge of the first shelf by the distance (d), the second side edges of each of the third and first shelves are aligned in substantially collinear relation to one another, the inner second panel-support mount of the first shelf is offset to lie a distance (D) from the second side edge of the article-support panel of the first shelf, the outer first panel-support mount of the third shelf is adjacent to the second side edge of the article-support panel of the third shelf to lie within a space defined between a second reference line that is arranged to lie in generally parallel relation to the second side edge of the third shelf and separated from the second side edge of the first shelf by the distance (D).

24. The storage unit of claim 23, wherein the distance (d) is about equal to the distance (D).

25. A storage unit comprising
a shelf-support system including a first rack, a second rack, a third rack, an a fourth rack, the second rack being arranged to lie between and in spaced-apart relation to each of the third and first racks, the first rack being arranged to lie between and in spaced-apart relation to each of the second and fourth racks, each of the racks including a shelf-support tube, and
shelving mounted on the first, second, third, and fourth racks to lie at a predetermined elevation above ground underlying the racks, the shelving including, in series, a third shelf coupled to the third and second racks, a first shelf coupled to the second and first racks, and a second shelf coupled to the first and fourth racks, each of the first, second, and third shelves having an article-support panel, a pair of inner and outer first panel-support mounts coupled to a first end of the article-support panel and arranged to engage a shelf-support tube in one of the racks, and a pair of inner and outer second panel-support mounts coupled to an opposite second end of the article-support panel and arranged to lie in spaced-apart relation to the pair of inner and outer first panel-support mounts to locate the article-support panel therebetween and to engage a shelf-support tube in another of the racks,
wherein the shelf-support tube of the first rack is arranged to lie between the article-support panels of the first and second shelves and the outer second panel-support mount of the second shelf, inner first panel-support mount of the first shelf, inner second panel-support mount of the second shelf, and outer first panel-support mount of the first shelf are arranged to engage the shelf-support tube of the first rack and lie in series along a length of the shelf-support tube of the first rack, and
wherein the shelf-support tube of the second rack is arranged to lie between the article-support panels of the third and first shelves and the outer second panel-support mount of the first shelf, inner first panel-support mount of the third shelf, inner second panel-support mount of the first shelf, and outer first panel-support mount of the third shelf are arranged to engage the shelf-support tube of the second rack and lie in series along a length of the shelf-support tube of the second rack.

26. The storage unit of claim 25, wherein the inner and outer first panel-support mounts of the second shelf are coupled to the shelf-support tube of the fourth rack and the inner and outer second panel-support mounts of the third shelf are coupled to the shelf-support tube of the third rack.

27. The storage unit of claim 25, wherein the inner first panel-support mount of the third shelf includes a horizontal plate arranged to overlie the second shelf-support tube and the outer second panel-support mount of the first shelf includes a horizontal plate arranged to overlie the second shelf-support tube and lie in substantially coplanar relation to the horizontal plate of the inner first panel-support mount of the third shelf.

28. The storage unit of claim 27, wherein the inner first panel-support mount of the third shelf further includes a first vertical plate coupled to a free end of the horizontal plate of the inner first panel-support mount of the third shelf and arranged to extend downwardly to lie between the second shelf-support tube and the second end of the article-support panel of the first shelf.

29. The storage unit of claim 28, wherein the outer second panel-support mount of the first shelf further includes a vertical plate coupled to a free end of the horizontal plate of the outer second panel-support mount and arranged to extend downwardly to lie between the second shelf-support tube and the first end of the article-support panel of the third shelf.

30. The storage unit of claim 27, wherein the outer second panel-support mount of the first shelf further includes a vertical plate coupled to a free end of the horizontal plate of the outer second panel-support mount and arranged to extend downwardly to lie between the second shelf-support tube and the first end of the article-support panel of the third shelf.

31. The storage unit of claim 25, wherein the inner first panel-support mount includes a first horizontal plate arranged to overlie the first shelf-support tube and the outer second panel-support mount includes a second horizontal plate arranged to overlie the first shelf-support tube and lie in substantially coplanar relation to the first horizontal plate of the inner first panel-support mount.

32. The storage unit of claim 31, wherein the inner first panel-support mount of the first shelf further includes a vertical plate coupled to a free end of the horizontal plate of the shelf and arranged to extend downwardly to lie between the first shelf-support tube and the second end of the article-support panel of the second shelf.

33. The storage unit of claim 32, wherein the outer second panel-support mount of the first shelf further includes a vertical plate coupled to a free end of the horizontal plate of the outer second panel-support mount of the first shelf and arranged to extend downwardly to lie between the second shelf-support tube and the first end of the article-support panel of the second shelf.

34. The storage unit of claim 31, wherein the outer second panel-support mount of the first shelf further includes a vertical plate coupled to a free end of the horizontal plate of the outer second panel-support mount of the first shelf and arranged to extend downwardly to lie between the second shelf-support tube and the first end of the article-support panel of the second shelf.
